(19) United States
(12) Patent Application Publication
(10) Pub. No.: US 2016/0171890 A1
(43) Pub. Date: Jun. 16, 2016

(54) DEVICE FOR DETECTING PROXIMITY OF A VEHICLE AND SYSTEM FOR MONITORING PARKING SPACES OF A PARKING LOT

(71) Applicant: KIUNSYS S.r.I., Campochiaro (Campobassc) (IT)

(72) Inventors: Nicola GALLI, San Giuliano Terme (Pisa) (IT); Marco MAGNAROSA, Pisa (IT); Paolo LANARI, Pisa (IT); Sandra CORREAS, Cascina (Pisa) (IT); Guido NENNA, San Vito Chietino (Chiet) (IT); Alfredo SALVATORE, Spinete (Campobasso) (IT)

(21) Appl. No.: 14/436,557

(22) PCT Filed: Oct. 18, 2013
(86) PCT No.: PCT/IB2013/059455

§ 371 Date: Apr. 17, 2015

(30) Foreign Application Priority Data
Oct. 22, 2012 (IT) FI2012A000223

(51) Int. Cl. G08G 1/14; G01S 15/04

(52) U.S. Cl. CPC G08G 1/14; G01S 15/04

(57) ABSTRACT

A device for detecting proximity adapted to monitor a parking space, which has relatively small dimensions, is autonomous from the energy point of view even when positioned in the middle of the parking space and does not require the provision of stations outside the parking space to be supplied by photovoltaic cells. The architecture of the device is organized in such a way as to be able to keep almost all its components turned off, which are all turned on only when there is the need to detect whether the parking space is occupied or free and only for the time strictly needed to perform this operation. There is further disclose an architecture of a monitoring device adapted to communicate with a plurality of devices for detecting proximity, to form a system for monitoring parking spaces of a parking lot.

### TECHNICAL FIELD

The present invention relates to electronic detection devices. More specifically, it relates to a device for detecting proximity adapted to be installed in a substantially central position of a parking space to indicate when the space is free or occupied to a remote monitoring control unit, and a related system for monitoring parking spaces in a parking lot.

### BACKGROUND

Today there is a growing demand for devices intended to monitor parking spaces to identify in real time the free parking spaces and those occupied. A device of this type is disclosed in the international patent application WO 2009154787 and is shown in FIGS. 1 and 2. It can be installed at the edges of a parking space and includes a proximity sensor for detecting the presence of a parked vehicle.

Such a known device works properly only if the vehicle is sufficiently close to the proximity sensor, which happens if the vehicle is properly parked inside the parking space and if it is not too short. Otherwise, it may indicate as free parking spaces occupied by wrongly parked vehicles, with a part out of the space, or by small cars.

The way that at the moment seems more promising to solve this problem of wrong detection of the presence of a parked vehicle is to install the detection device in a substantially central area of the parking space, so as to be able to detect the presence of a mini-car or a wrongly parked vehicle astride a line that delimits the space. A device of this type is the parking sensor marketed under the name “Sky Light System” produced by Nabla Quadro, shown in FIG. 3 and subject of the international application WO 2009/074961. It is able to detect the presence of a vehicle above through an analysis of the incident ambient light, altered by the passage and/or by the presence of a motor vehicle.

The energy required for operation is supplied by a non-rechargeable lithium thionyl chloride battery, which has a relatively high capacity and must be periodically replaced, resulting in maintenance costs to be multiplied by the number of detection devices installed.

### SUMMARY

In theory, the detection device shown in FIG. 3 may be made autonomous from an energy point of view simply by providing it with at least one photovoltaic cell and a rechargeable battery. However, such a device is normally placed in the shadow of a parked vehicle, whereby the amount of light that the photovoltaic cell could convert into electricity to recharge the battery would be strongly limited, and then it would run down quickly. This known device hypothetically so modified would not therefore be able to function properly and indicate that the space is occupied if the vehicle remains parked for several days in a row. For this reason, it is believed that the design choice to provide this known device with a high-capacity battery is a choice almost forced and that it is pretty much useless to provide it with a photovoltaic cell.

Despite what could easily be claimed until you try to implement a prototype of proximity detection device capable of functioning with a non-passive energy balance in the foregoing conditions under which it is intended to operate, providing the known detection devices with at least one photovoltaic cell and with a rechargeable battery collides with the need to ensure that the devices can work properly even if the photovoltaic cell remains in the shadow for several days in a row due to a parked vehicle.

This problem may be obviated by installing the photovoltaic cell outside the parking space and electrically connecting it to a detection device installed in the middle of the parking space, but that would mean having to provide existing parking lots with ad-hoc poles electrically connected to the devices for supplying them, which is actually less convenient than using a high-capacity battery.

A device for detecting proximity would therefore be desirable, adapted to monitor a parking space, which has relatively small dimensions, is autonomous from the energy point of view even when positioned in the middle of the parking space and does not require the provision of stations outside the parking space to be supplied by photovoltaic cells.

A particular architecture of device for detecting proximity has been found, structured in such a way as to be able to function with an average energy consumption less than what a photovoltaic cell could provide when installed in the middle of a parking space averagely occupied by a motor vehicle.

To achieve this object, apparently inconsistent with the above conditions, the architecture of the detection device of the present disclosure was organized in such a way as to be able to keep almost all its components turned off, which are all turned on only when there is the need to detect whether the parking space is occupied or free and only for the time strictly needed to perform this operation.

This result was obtained through a device for detecting proximity of a motor vehicle, comprising:

at least one supply photovoltaic cell, arranged on a top surface of the device,

a rechargeable accumulator of electric energy functionally coupled to the photovoltaic cell such as to be charged when the photovoltaic cell is illuminated,

at least one proximity sensor configured for generating detection signals adapted to flag presence or absence of a vehicle in the proximity of the detection device,

a microprocessor connected to the rechargeable accumulator such as to be permanently supplied thereby, configured for:
controlling the proximity sensor to make it detect presence or absence of a vehicle in the proximity of the detection device,
receiving the detection signals,
transmitting, towards a monitoring control unit, information signals for flagging presence or absence of a vehicle,
   at least one controlled supply switch through which all the electric and electronic devices of the detection device are supplied by the rechargeable accumulator but said microprocessor, the switch being configured for disconnecting from the rechargeable accumulator and leaving without power supply, or for connecting to the rechargeable accumulator and supplying, all components of the detection device but the microprocessor,
   the microprocessor being configured for controlling the controlled switch such to close it when a detection is to be performed and to open it when the detection is finished, and for entering in a stand-by functioning state from which resuming when a detection is to be performed. The detection device is configured in such a way as to:
be installed in the middle of a parking space to let emerge the top surface with the photovoltaic cell and be entirely below a vehicle parked in the space,
receive operating energy from the external environment exclusively through the photovoltaic cell(s).

A monitoring control unit architecture is further disclosed, which can be used in combination with one or more devices for detecting proximity, connected therewith for forming a monitoring system of parking spaces in a parking lot.

The claims as filed are an integral part of this description and are incorporated herein by reference.

### BRIEF DESCRIPTION OF THE DRAWINGS

FIGS. 1 and 2 show a known system for monitoring a parking lot installed at the edges of a parking space.

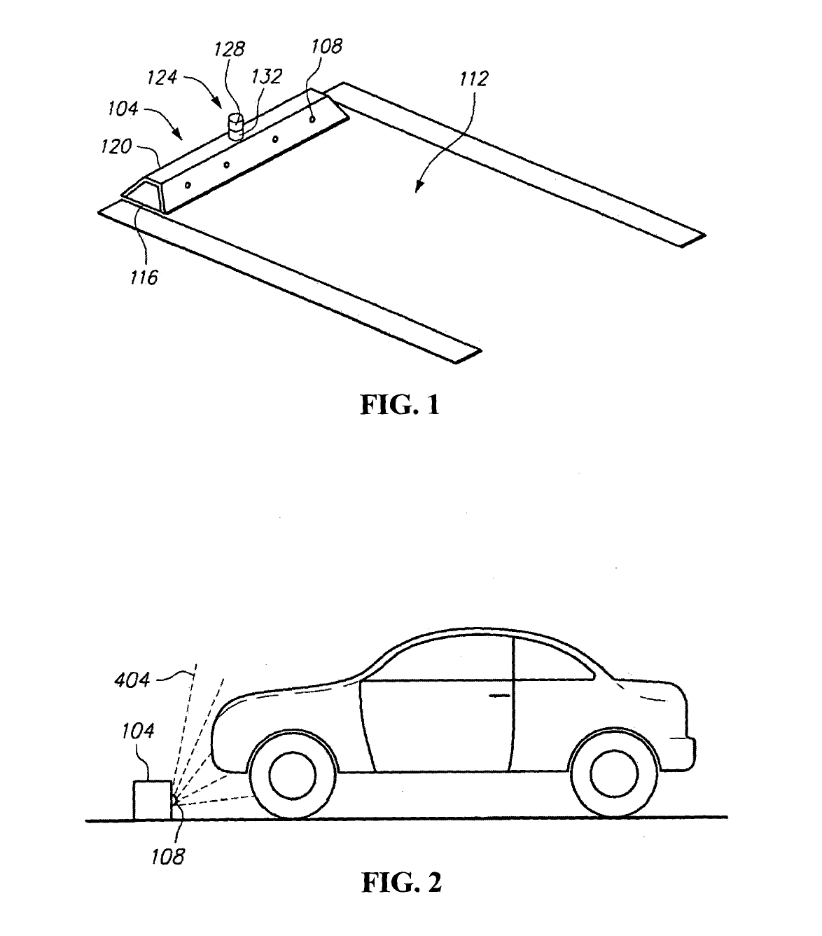

FIG. 3 shows another known system for monitoring a parking lot, having proximity devices installed substantially in the middle of the parking spaces.

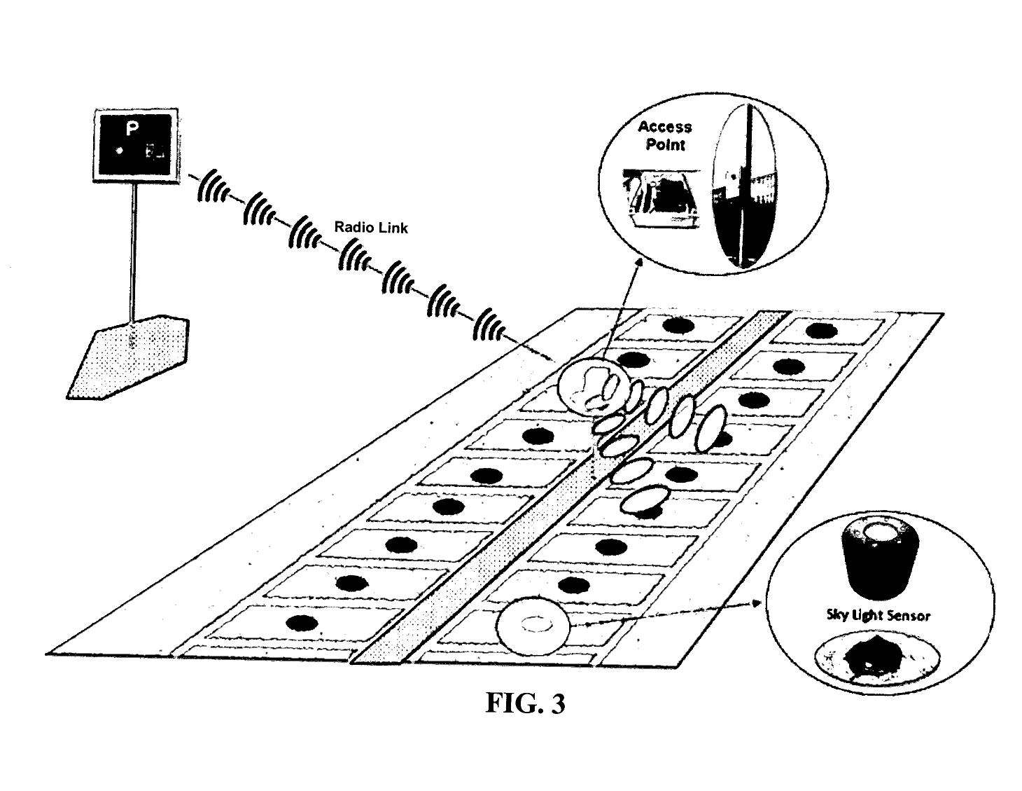

FIG. 4 shows a basic scheme of a system for monitoring a parking lot according to the present disclosure.

FIG. 5 shows a block diagram of a device for detecting proximity according to the present disclosure which can be used in a system for monitoring a parking lot.

FIGS. 6 and 7 are photographs of a working prototype of an energy-autonomous device for detecting proximity according to the present disclosure.

FIG. 8 shows a flow chart which provides an example of a sequence of operations performed by a device for detecting proximity according to the present disclosure.

FIGS. 9a and 9b schematically show a device for detecting proximity incorporating an RFID reader installed in a parking space and completely below a motor vehicle.

FIG. 10 shows a block diagram of a monitoring control unit according to the present disclosure, adapted to communicate with one or more devices for detecting proximity in FIG. 5 to constitute a system for monitoring parking spaces in a parking lot.

FIG. 11 is a photograph of a working prototype of a monitoring control unit according to the present disclosure.

FIG. 12 shows a flow chart which provides an example of a sequence of operations performed by a monitoring control unit according to the present disclosure.

### DESCRIPTION OF EXEMPLARY EMBODIMENTS

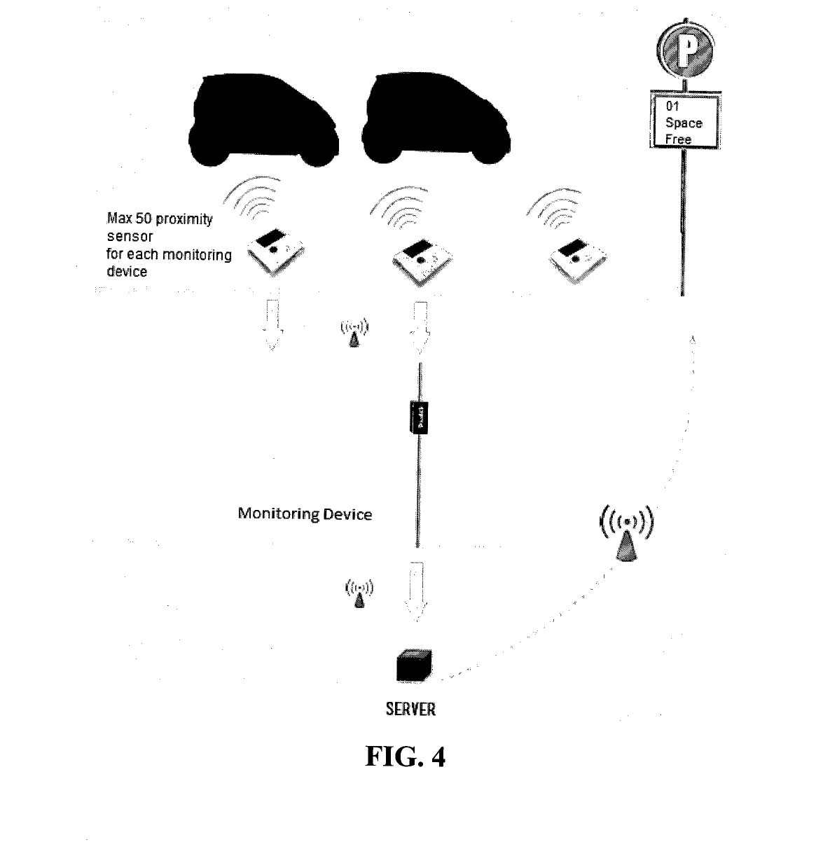

FIG. 4 shows a principle scheme of a system for monitoring parking spaces in a parking lot, comprising a plurality of devices for detecting proximity according to the present disclosure, and a monitoring control unit connected therewith and interfaced with a central server to collect information about occupied and free parking spaces.

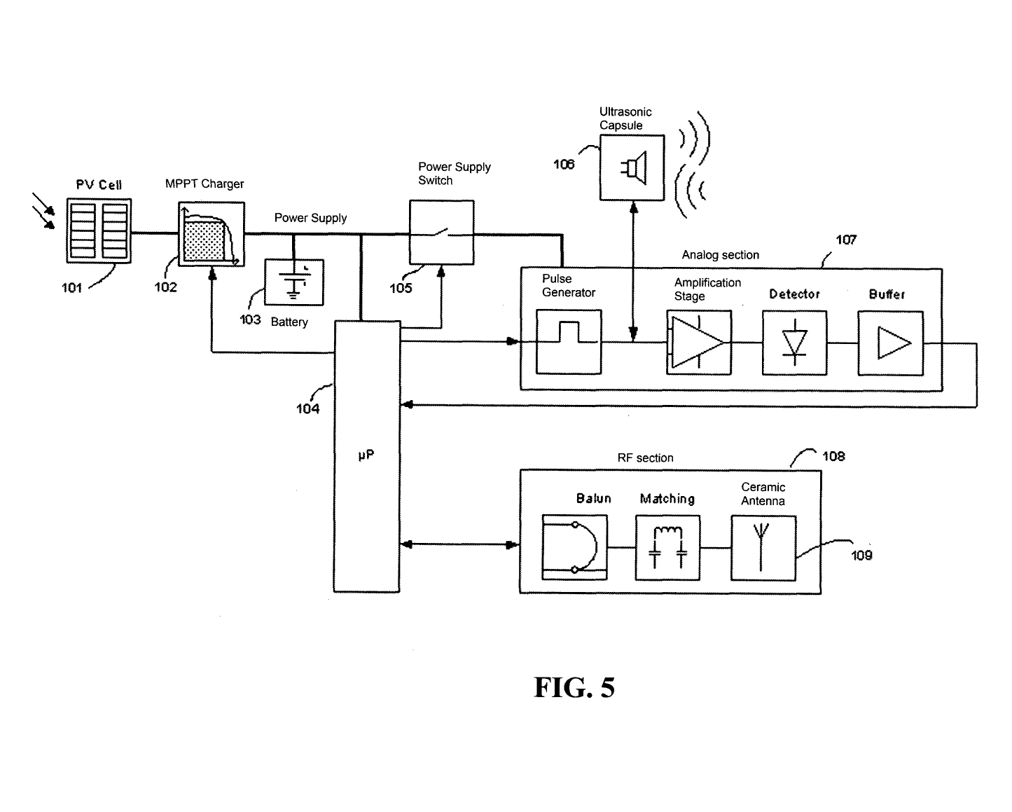

A block diagram of a particular embodiment of the device for detecting proximity according to the present disclosure is shown in FIG. 5. It substantially comprises at least one photovoltaic cell 101, a rechargeable electric energy accumulator 103, a microprocessor 104 permanently connected to accumulator 103, a controlled switch 105 for supplying all the other components of the device. In this architecture, the microprocessor is the only component to be permanently supplied, all the other components may be disconnected from power supply and turned off by opening switch 105. It is energetically autonomous because all these energy-consuming components, among which the proximity sensor and possibly the amplification stages in cascade thereto, are powered by the rechargeable battery only if the power switch is closed by the microprocessor itself, otherwise they remain all off, without affecting the proper functioning of the detection device.

When the proximity sensor has performed a detection and reported the outcome to the microprocessor, the latter opens the power switch so as to completely turn off all the detection section (which includes the proximity sensor), then transmits to a remote monitoring control unit that parking space is occupied/free and sets to a low-power operating state (stand-by). The microprocessor resumes from the stand-by state only when a new detection must be performed, preferably at predetermined intervals.

In the practice, most of the time the rechargeable battery must only maintain the minimum functions (stand-by) of the microprocessor, because the other components of the parking sensor are only supplied when it is necessary to perform a detection, otherwise they remain off. Simulations carried out by the Applicant have shown that the device for detecting proximity of the present disclosure has a positive energy balance in actual operating conditions.

Optionally, but not necessarily, these components can be supplied and resume their normal operation in a substantially immediate manner when the device is queried by a monitoring control unit.

In the preferred embodiment shown in FIG. 5 there are also indicated other circuit blocks that perform ancillary functions. The meaning and the function performed by each block shown is summarized in the following table:

101 Photovoltaic cells for recharging the battery

102 MPPT (Maximum Power Point Tracking) battery charger for maximizing the energy collected by the photovoltaic cells

103 Rechargeable battery, preferably the LiFePO4 type

104 Microprocessor for controlling the system, the ultrasonic pulse generation, the processing of the echo signal and the radio frequency two-way transmission (via integrated transceiver)

105 Switch for disabling the power supply of the analog section in order to reduce consumption

106 Ultrasonic capsule for sending the obstacle detection pulse and receiving the echo

107 Analog section comprising the stages for driving the ultrasonic capsule and the conditioning of the echo signal

108 RF section for the adaptation and the two-way transmission of the radio frequency signal

109 Ceramic antenna

According to a circuit configuration commonly used in the practice, the photovoltaic cell or cells charge accumulator 103 when they are illuminated and are electrically isolated from it when they are in the shadow.

Preferably, the photovoltaic cells are coupled to the rechargeable accumulator 103 through a maximum power point tracking circuit (MPPT—Maximum Power Point Tracking), optionally controlled by the microprocessor itself, so that they work at the point of maximum yield for any condition of irradiation.

Preferably, the photovoltaic cells are of the high efficiency type, i.e. they have a yield greater than 20%, such as the photovoltaic cells marketed under the name KXOB-12X1-22 produced by IXYS.

To avoid using a voltage regulator for supplying the microprocessor, which would contribute to increasing consumption, accumulator 103 is selected so that the nominal voltage thereof coincides with the supply voltage of the microprocessor and the latter is supplied by means of a direct connection with the accumulator. Preferably, but not necessarily, the rechargeable accumulator is a lithium ion type battery with a nominal voltage of 3.2 V directly connected to the microprocessor.

Preferably, but not necessarily, the proximity sensor is an ultrasonic sensor, for example of the type marketed under the name 12H01-TK054L356-01 manufactured by AUDIOWELL.

Preferably but not necessarily, the device has a substantially analog detection section, which comprises a driver directly controlled by the processor to control the proximity sensor and the analog amplification stages in cascade to the latter.

Preferably, but not necessarily, the microprocessor is provided with an antenna integrated in the casing of the detection device, of the type described in the article by R. Caso, A. Michel, P. Nepa, G. Manara, R. Massini “Design and Performance of an Integrated Antenna for a 433 MHz Car Park Monitoring System”, Proceedings of the 2012 IEEE International Symposium on Antenna and Propagation. In order to use such an antenna, which has a better efficiency compared to the typical ceramic antennas and therefore allows the transmission power to be reduced, communications between the parking sensor and the detection control unit are performed at a frequency of 433 MHz.

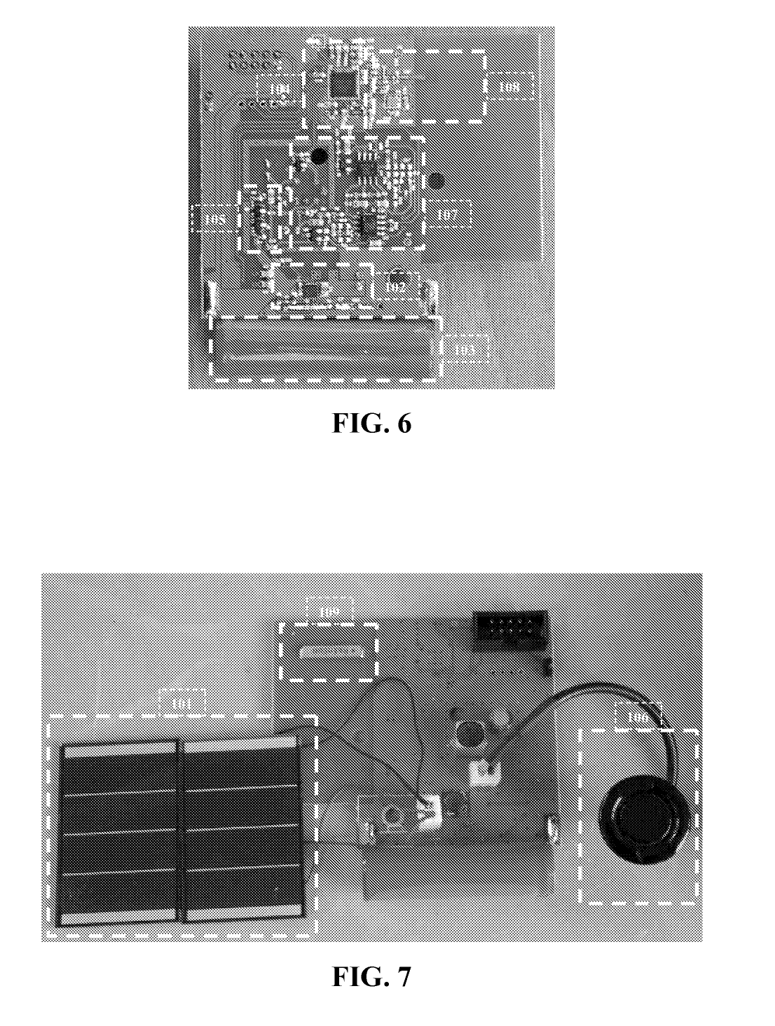

FIGS. 6 and 7 are photographs of a working prototype of an energy-autonomous device for detecting proximity according to the present disclosure. It has small dimensions and can be easily installed in the middle of a parking space, in the asphalt or above ground.

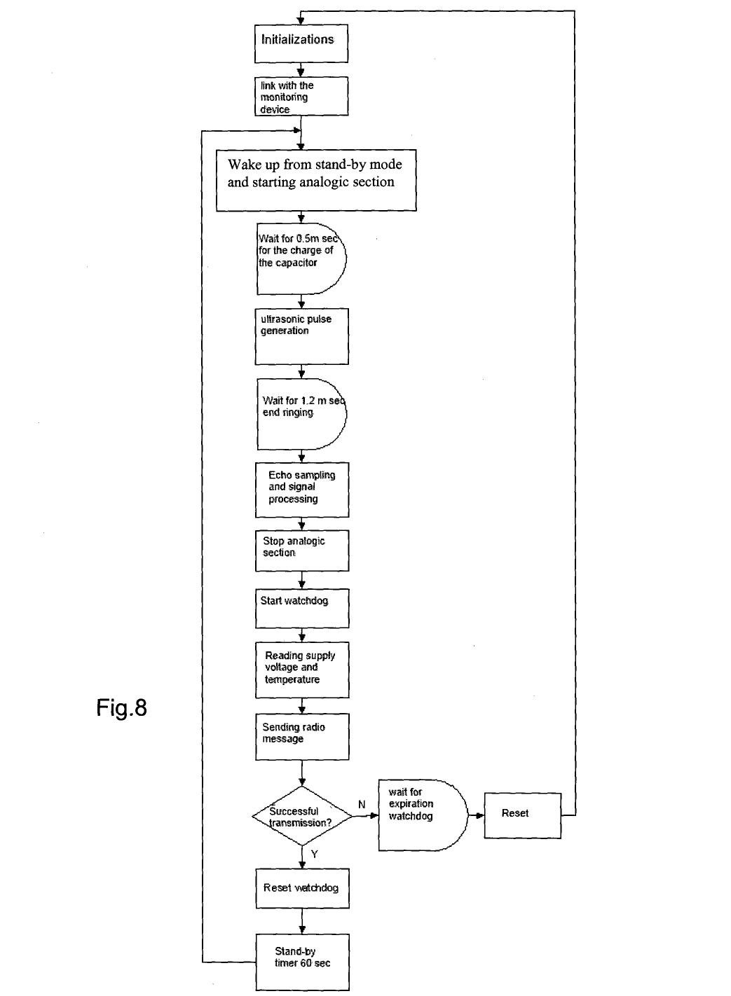

FIG. 8 is a flow chart of an example of a sequence of operations that can be performed by the prototype shown in FIGS. 6 and 7. Substantially, the microprocessor of the device for detecting proximity implements a connection with a monitoring control unit, turns on the analog detection section and performs a detection of the presence or absence of a vehicle thereon; then, it turns off all the components, transmits the results of the detection to the monitoring control unit and sets to stand-by, waiting to perform a new detection.

The detection device provides for the use of a single ultrasonic sensor, both for the transmission of the detection pulse and for receiving the echo. Such a mode provides a reduced level of consumption capable of ensuring a lifetime of the system and of the battery of more than 48 months. In fact, the use of the ultrasonic technology per se is not sufficient to ensure an actual optimization of consumption. The only ultrasonic sensor is conveniently managed using such an operating procedure as to optimize each operation. According to one embodiment, the detection device is managed with the following procedure:
it remains in stand-by for a minute;
upon wake up from the stand-by mode, it sends a burst of 4 pulses to the sensor;
after 1.2 msec, it performs 24 samplings of the analog response signal and calculates the mathematical average (24 appears to be the minimum number of pulses to ensure that there is sufficient delay between sending data and reading by the sensor);
after a further waiting time of 1.2 msec, reading of the analog channel is repeated without stimulating the sensor in order to measure the background noise;
the measure consists of the average of 16 samplings from which the 4 highest values are discarded (as they may be spurious pulses due to the activity of other nearby sensors or other sources of environmental noise);
the two values are transmitted by the sensor to the control unit;
the sensor returns to stand-by.

Such a procedure allows a reading of the actual occupation of the parking spaces to be obtained with reduced energy consumption and thus for an average time equal to twice the known management systems of parking lots.

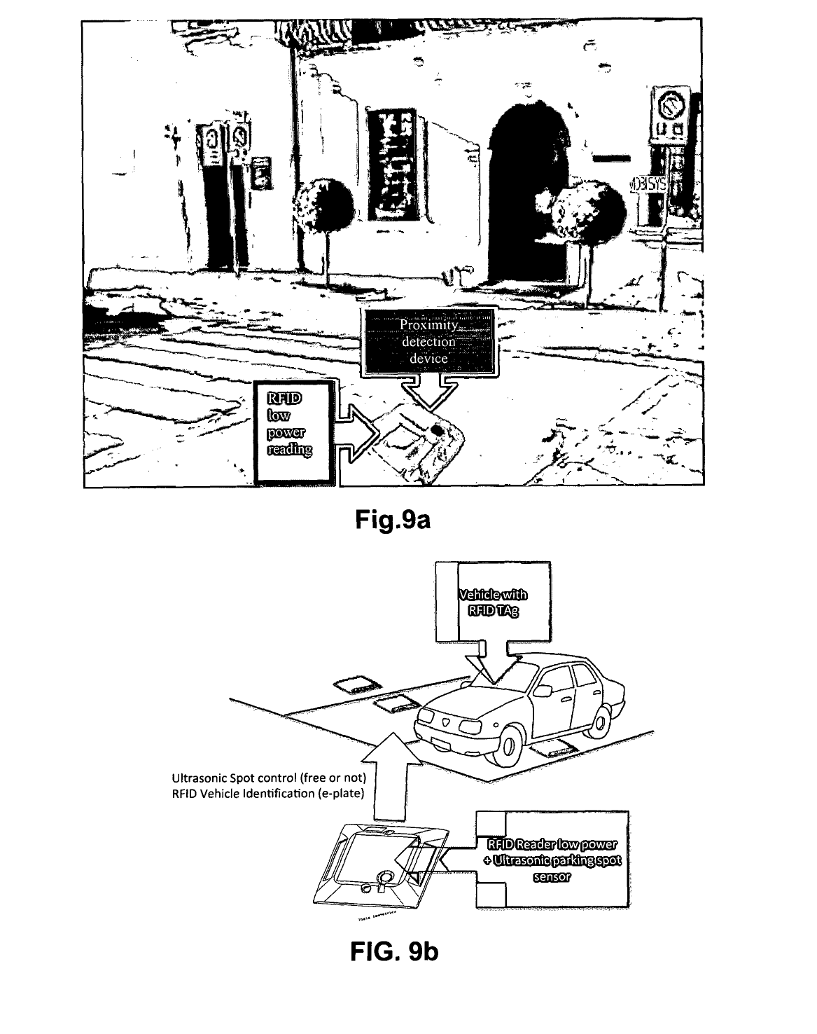

The device for detecting proximity of a vehicle also allows the integration of an RFID reader capable of recognizing any RFID tags on the parked vehicle, as schematically shown in FIGS. 9a and 9b. Further checks may be made in this way, in particular:
whether a parking space is free or occupied;
whether a parking space is occupied by an authorized vehicle or not;
recognizing which vehicle (marked with RFID) is.

In this case, the detection device will have the components shown in FIG. 5 and in addition (not shown in the figures), an RFID reader of the “Low power” type, functioning on UHF band, which is also supplied through the power switch 105, adapted to detect a vehicle at a maximum distance of 70 cm. The fact that the RFID reader is supplied through switch 105 allows it to be turned off when needed, along with all the other electric and electronic components but the microprocessor, so as to reduce consumption to a minimum.

The RFID reader will provide information that will allow checking whether the parked vehicle is actually authorized to park in that specific space.

Optionally, the RFID reader may be provided with an intermittent audible warning device which can be activated, for deterrence purposes, in the case of unauthorized parking.

The device for detecting proximity can be interfaced with any monitoring control unit adapted to collect the results of the detections, in order to constitute a system for monitoring parking spaces in a parking lot. Such a control unit will preferably but not essentially consist of a microprocessor 104 supplied by a rechargeable accumulator 103, kept under charge by at least one photovoltaic cell 101, which communicates via radio through the RF section 108 with the devices for detecting proximity and transmits the data collected to a central server via a SIM card 113 and a GPRS antenna 114.

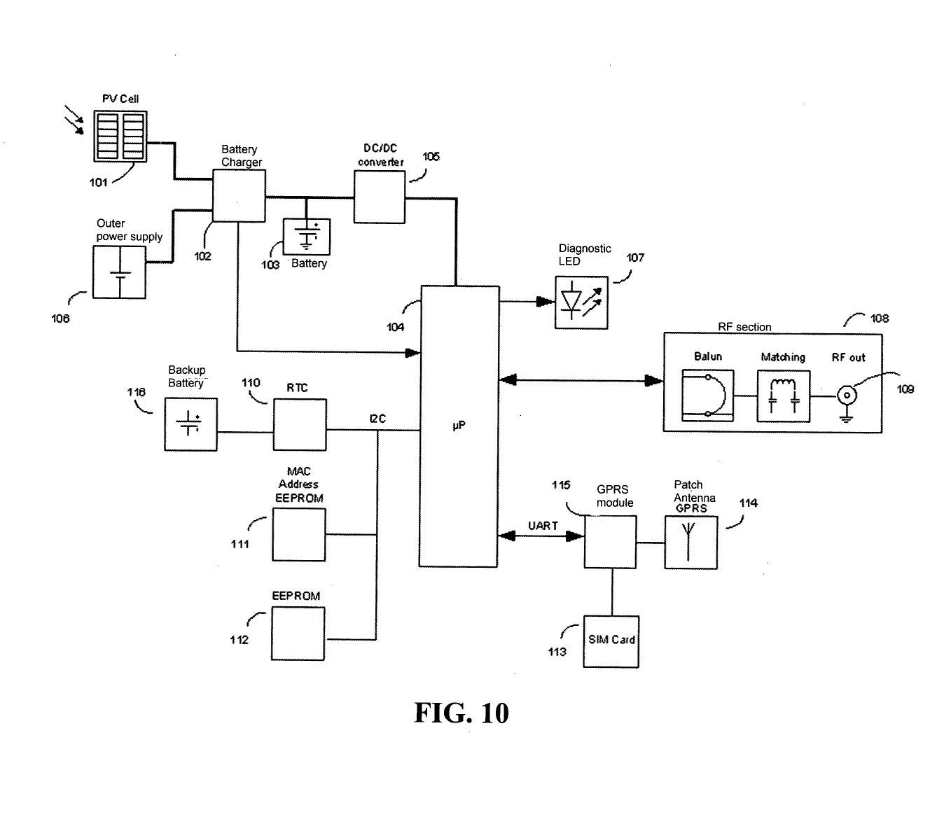

A preferred architecture of monitoring control unit suitable for the purpose is shown in FIG. 10. The meaning and the function performed by each block shown is summarized in the following table:

| | |
|---|---|
| 101 | Photovoltaic cells for recharging the battery |
| 102 | Battery charger |
| 103 | Li-Ion 10 Ah battery |
| 104 | Microprocessor for controlling the system, the communication |
| | with the GPRS module and the 433 MHz two-way transmission |
| | (via integrated transceiver). |
| 105 | DC-DC converter |
| 106 | External DC supply for recharging the battery |
| 107 | Diagnostic LED |
| 108 | RF section for the adaptation and the two-way transmission |
| | of the signal at 433 MHz |
| 109 | Connector for external antenna at 433 MHz |
| 110 | Real Time Clock |
| 111 | EEPROM with MAC address for unique identification of the |
| | control unit |
| 112 | EEPROM for permanent data storage |
| 113 | SIM Card |
| 114 | Patch antenna for GPRS |
| 115 | GPRS communication module |
| 116 | Backup battery for RTC |

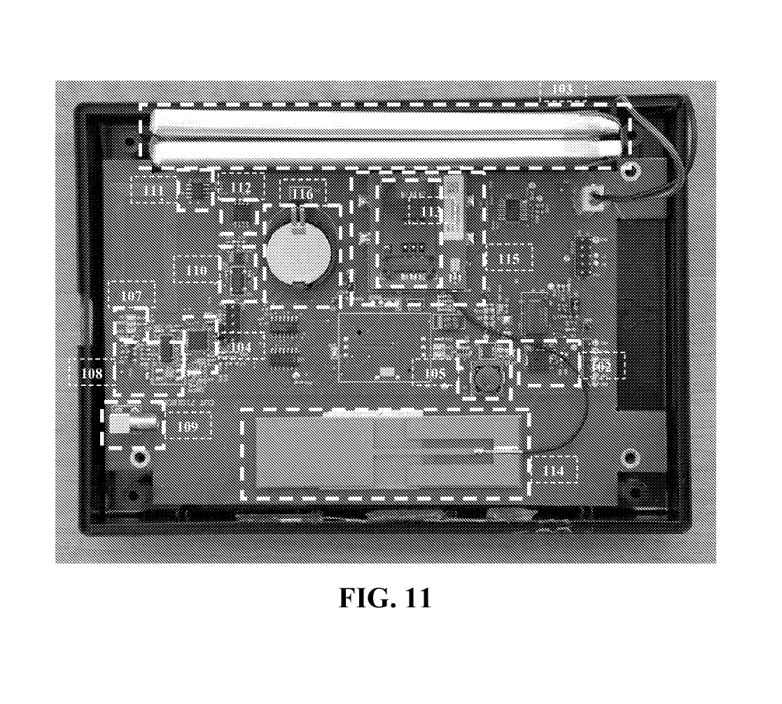

FIG. 11 is a photograph of a working prototype of the monitoring control unit shown in FIG. 10. Its small dimensions make it easily embeddable in virtually any existing parking meter, so it does not require the implementation of a dedicated pole or tower. It is adapted to interface with a plurality of devices for detecting proximity to constitute a monitoring system able to provide a map of the free/occupied parking spaces in a parking lot.

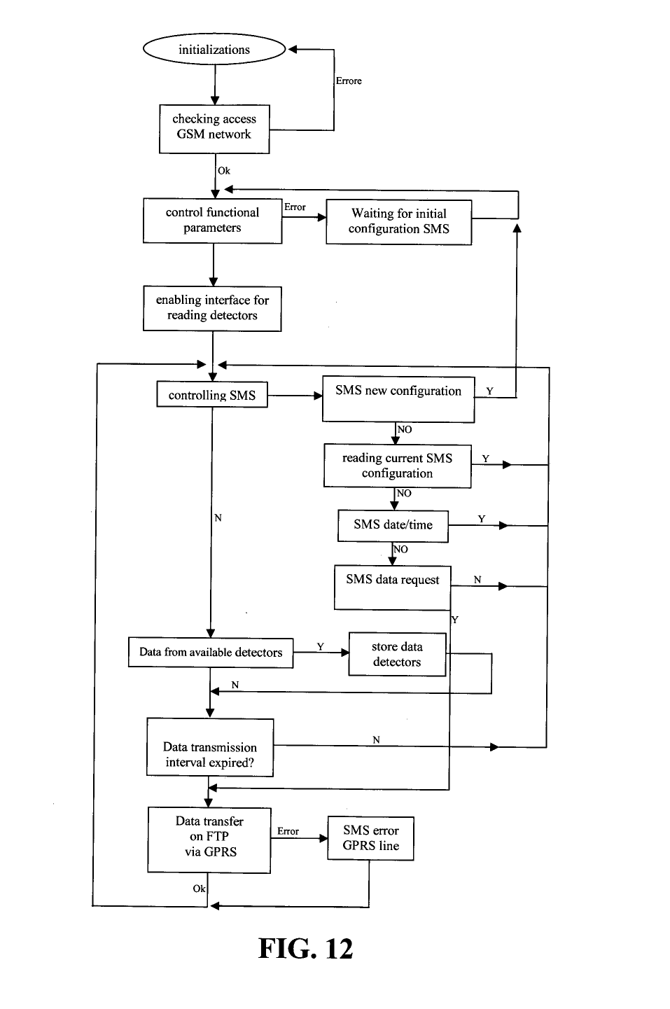

FIG. 12 shows an exemplary flow chart of operations that can be performed by the monitoring control unit in FIG. 10. Initially, the control unit checks the availability of access to the GSM network, so as to be sure to be able to provide information about the occupation status of the parking spaces. Once the presence of the GSM network has been verified, the control unit collects information from devices for detecting proximity and sends it to a central server, which makes it accessible by users.

If the detection device also incorporates an RFID reader of RFID tags installed on motor vehicles, the monitoring control unit will receive information about the vehicle parked and will be able to detect whether it is actually authorized to occupy the space, and optionally alert the authorities for the possible removal of the motor vehicle.

1. Device for detecting proximity of a vehicle, comprising:
a supply photovoltaic cell arranged on a top surface of the device,
a rechargeable accumulator of electric energy functionally coupled to said photovoltaic cell such to be charged when said photovoltaic cell is illuminated,
a proximity sensor configured for generating detection signals adapted to flag presence or absence of a vehicle in proximity of the device,
a microprocessor connected to said rechargeable accumulator such to be permanently supplied thereby, configured for:
controlling said proximity sensor to make it detect presence or absence of a vehicle in proximity of the device,
receiving said detection signals,
transmitting, towards a monitoring device, information signals for flagging presence or absence of a vehicle,
a supply controlled switch, through which the rechargeable accumulator supplies with power all the electric and electronic components of the device but said microprocessor, the switch being configured for disconnecting from said rechargeable accumulator and leaving without power supply, or for connecting to said rechargeable accumulator and supplying, all components of the device for detecting but said microprocessor, said microprocessor being configured for controlling said supply controlled switch such to close it when a detection is to be performed and to open it when the detection is finished, and for entering in a stand-by functioning state from which resuming when a detection is to be performed,
said detecting device being configured so as to:
be installed in the middle of a parking space to let emerge the top surface with the photovoltaic cell and be entirely below a vehicle parked in the space,
receive operating energy from the external environment exclusively through the photovoltaic cell(s).

2. Device for detecting proximity according to claim 1, wherein said rechargeable accumulator delivers a nominal voltage corresponding to the nominal supply voltage of the microprocessor, and said microprocessor is configured to be supplied by the accumulator through a direct connection.

3. Device for detecting proximity according to claim 2, wherein said rechargeable accumulator is a rechargeable Lithium ion battery, adapted to supply a nominal voltage of 3.2V, directly connected to the microprocessor.

4. Device for detecting proximity according to claim 1, wherein the proximity sensor is an ultrasonic sensor.

5. Device for detecting proximity according to claim 1, comprising:
a driver, configured for being controlled by the microprocessor, adapted to drive said proximity sensor; and
an amplifier, configured for amplifying detection signals generated by said proximity sensor and for providing them to the microprocessor.

6. Device for detecting proximity according to claim 1, comprising a maximum power point tracking circuit functionally connected to said photovoltaic cell, configured for making said photovoltaic cell work in a maximum yield functioning region.

7. Device for detecting proximity according to claim 6, wherein said maximum power point tracking circuit is controlled by the microprocessor.

8. Device for detecting proximity according to claim 1, wherein said microprocessor is configured to receive from the monitoring device command signals for performing a detection.

9. Device for detecting proximity according to claim 1, further comprising an RFID reader capable of recognizing RFID tags on vehicles, said RFID reader being configured so as to be supplied with power by said rechargeable accumulator only through the controlled supply switch.

10. System for monitoring parking spaces of a parking lot, comprising at least one device for detecting proximity according to one of the preceding claims, and a monitoring device that includes:
a power supply circuit;
a microprocessor functionally connected to said power supply circuit, configured for:
communicating with said at least one device for detecting through a remotely transceiving antenna and for collecting said information signals for flagging presence or absence of a vehicle in a respective parking space,
being interrogated and for transmitting to a server, through a SIM card, information about whether said parking space is free or occupied.
